(19) United States
(12) Patent Application Publication
(10) Pub. No.: US 2006/0013633 A1
(43) Pub. Date: Jan. 19, 2006

(54) Electronic device

(76) Inventor: Aimo Nummela, Turku (FI)

Correspondence Address: YOUNG & THOMPSON, 745 SOUTH 23RD STREET, 2ND FLOOR, ARLINGTON, VA, 22202, US

(21) Appl. No.: 11/178,391

(22) Filed: Jul. 12, 2005

Related U.S. Application Data
(63) Continuation of application No. PCT/FI04/00016, filed on Jan. 13, 2004.

(30) Foreign Application Priority Data
Jan. 14, 2003 (FI) 20030052

(51) Int. Cl. B41J 5/08

(52) U.S. Cl. 400/472

(57) ABSTRACT

An electronic device, in particular a mobile phone or a communicator, a power source element thereof and a method of optimising the structure of an electronic device. The device comprises a power source element and a keyboard, the keyboard including a keydome. The keydome is arranged in the power source element.

This application is a continuation of PCT International Application No. PCT/FI2004/000016 filed on Jan. 13, 2004 under 35 U.S.C. § 371. The entire contents of which are hereby incorporated by reference.

### BACKGROUND OF THE INVENTION

The invention relates to an electronic device which comprises a power source element and a keyboard, which includes a keydome.

The invention also relates to a power source element for an electronic device which comprises a power source and a casing covering it.

The invention further relates to a method of optimising the structure of an electronic device, which comprises a power source element and a keyboard, which includes a keydome.

Mobile stations, communicators, palmtops, PDA devices (personal digital assistant), laptops and combinations thereof as well as other similar electronic devices exist which include a keyboard-operable user interface. The cross-section of these devices typically comprises outer covers, an encased battery element, a body, a circuit board with its components, a keydome and a keyboard. These structures define a certain minimum thickness for the electronic device, which consists not only of the thicknesses of the structures but also of the tolerances between the structures.

In the design of electronic devices, one of the most important goals is to achieve as small outer dimensions for the device as possible. The dimensioning and fitting of the structures listed above is nowadays optimised so that the basic structure of the devices does not allow a substantial reduction in the outer dimensions of electronic devices in respect of thickness. On the other hand, it is difficult to increase free volume inside the outer cover without increasing its dimensions. Furthermore, the number of structures is rather large in the device, which causes additional assembly costs.

### BRIEF DESCRIPTION OF THE INVENTION

The object of the invention is to provide a new and improved electronic device, power source element for an electonic device and method of optimizing the structure of an electronic device to solve the above-mentioned problems.

The electronic device according to the invention is characterized in that the keydome is arranged in the power source element.

The power source element of the electronic device according to the invention is characterized in that the power source element further comprises a keydome.

The method of optimising the structure of an electronic device is characterized in that the keydome is attached to the power source element.

An advantage of the invention is that when the keydome of the electronic device is integrated into the power source element, its thickness can be reduced since the integrated structure is thinner than the structure consisting of a separate power source element, a keydome with its supportive structures, and necessary tolerances. In addition, the integrated structure simplifies the assembly of the device.

The idea underlying a preferred embodiment of the invention is that the keydome is arranged as part of the protective cover of the power source. An advantage is that the protective cover may be thinned at the keydome or it may even be omitted altogether, which results in a yet thinner structure.

The idea underlying a second preferred embodiment of the invention is that the power source element is integrated into the cover of the device. An advantage is that the structure and assembly of the device are further simplified and the thickness can be reduced since the cover functions as the protective cover of the power source element and a separate protective cover is unnecessary.

The idea underlying a third preferred embodiment of the invention is that the keys related to the keydome are arranged in the power source element. An advantage is that the assembly of the device becomes even simpler.

The idea underlying a fourth preferred embodiment of the invention is that the power source element is arranged as part of the device's supporting structure. An advantage is that the device does not necessarily require a separate supporting body, which enables increasing the free volume of the device without increasing the outer dimensions, or decreasing the device's outer dimensions.

### BRIEF DESCRIPTION OF THE FIGURES

The invention will be described in greater detail in the accompanying drawings, in which

FIG. 1 schematically illustrates a prior art electronic device as a cross-section at the keyboard,

FIG. 2 schematically illustrates an electronic device according to the invention as a cross section at the keyboard, and

FIG. 3 schematically illustrates another electronic device according to the invention as a cross section at the keyboard.

For the sake of clarity, the figures illustrate the invention in a simplified manner. Like reference numbers refer to like parts in the figures.

### DETAILED DESCRIPTION OF THE INVENTION

FIG. 1 schematically illustrates a prior art electronic device as a cross section at the keyboard. In this case, the electronic device is a mobile station. It should be noted that hereinafter the ‘electronic device’ is referred to as the ‘device’ in this description.

The cross section of the device consists of a front cover 1 and a back cover 2, which form a space, where most of the other device components are mounted. The components include a power source element 3, which typically comprises the actual power source, which is most often arranged inside a plastic protective cover 19, necessary contacts for connecting the device to a power circuit and necessary arrangements for attaching the power source element 3 to the device. The power source element 3 is either a chargeable battery, for example a Li ion, a Ni metal hybrid, a Li polymer or another battery known per se, or a disposable battery.

The device further comprises a body 4, most of which is usually arranged inside the cover parts 1, 2. The body 4 is made of plastic, metal or a combination thereof. The body 4 supports the device structure and functions as a mounting base for some components. Alternatively, the body may be integrated into the cover structure.

The device further comprises a circuit board 5, to which electronic components of the device are attached in a known manner. These components are not illustrated in detail, but the space required by them is illustrated by an area 6 defined by broken lines. The circuit board 5 is attached to the body 4 by attachment means, which are not shown in the figure.

An auxiliary body 7 is arranged on top of the circuit board 5 and a keydome 8 on top of this. The auxiliary body 7 keeps the keydome 8 in the right place in the device. The keydome produces the key response sensed by the keyboard user and converts a key press into an electric signal.

Keyboard 20 keys 10 are arranged in immediate connection with the keydome 8. In the solution shown here, the keys 10 are arranged in a keymat 11, which attaches the keys to each other and by means of which the keys 10 are attached to the front cover 1. The keys 10 and the keymat 11 are often made of one and the same piece, which has been manufactured from plastic material by pressing or injection moulding.

Each key 10 includes a protruding press 12 directed towards the keydome 8. Correspondingly, the keydome 8 is provided with membrane switches 9 at the keys 10. When a key 10 is pressed, the press 12 presses the membrane switch 9 under it, which generates an electric signal, which is transmitted forward via conductors provided in the keydome 8. The membrane switch 9 produces a key response and the force that returns the key to its upper position. Instead of the membrane switch 9, other structures known per se can naturally also be applied to produce the key response and the force that returns the key to its upper position.

The power source element 3, body 4, circuit board 5, auxiliary body and keydome 8 are arranged one on top of the other in the device's cross section. The thickness of these components together with the tolerances between them defines the minimum thickness for the device.

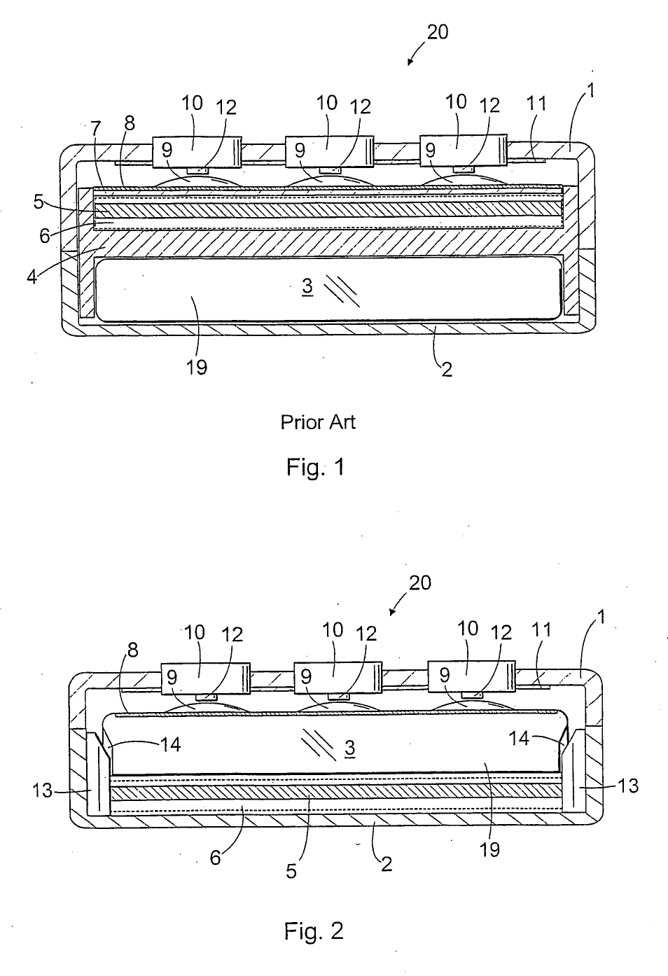

FIG. 2 schematically illustrates an electronic device according to the invention as a cross section at the keyboard. The device comprises an outer cover, which in the embodiment shown here comprises a front cover 1 and a back cover 2. The device further includes a power source element 3, a circuit board 5 and a keyboard 20 with its keydome 8. The keys 10 of the keyboard 20 are attached to one another by a keymat 12. The keymat 12 is not, however, necessary but the keys 10 may be separate components attached to the front cover 1 or keydome 8, for example.

The device comprises neither a body 4 nor an auxiliary body 7, but the keydome 8 and its membrane switches 9 are attached to the power source element 3, more precisely to its protective cover. The attachment can be implemented so that the keydome cannot be detached from the power source element 3 without breaking it, for example by gluing or welding, or so that the keydome is detachable from the power source element 3, e.g. by screw fastening or an openable adhesive joint.

The keydome 8 is integrated into the protective cover 19 of the power source; in other words, in addition to its conventional functions, the keydome 8 protects the power source. This enables thinning of the protective cover 19 at the keydome 8, which allows a reduction in the device thickness. The protective cover 19, for example, protects the power source, and in some embodiments it holds separate battery cells together.

The keydome 8 comprises necessary conductors for transmitting the signal generated by a key press forward. To simplify the presentation, the conductors are not shown in the figures.

The circuit board 5 of the device and its components are placed on the opposite side to the power source element 3 with respect to the keyboard.

The back cover 2 of the device is provided with attachment members 13 and the protective cover of the power source element 3 is provided with counter members 14 for the attachment members. The members 13, 14 preferably attach the power source element detachably to the device cover. These attachment members 13 and their counter members 14 are preferably shaped so as to provide the attachment with a sufficient firmness to allow the power source element 3 to function as the supporting structural element, which supports the device cover and receives static and dynamic loads directed to the device. Thus separate frameworks are not necessarily needed, which allows an increase in the free volume of the device without increasing the outer dimensions or a reduction in the outer dimension of the device. Separate frameworks may naturally be used in the other parts of the device, if necessary.

It is naturally clear that the attachment members 13 and their counter members 14 may alternatively be mounted in the front cover 1 or both in the front cover 1 and in the back cover 2.

The circuit board 5 is also attached to the device cover. In the device shown in the figure, it is attached to the back cover 2, but it can naturally also be attached to the front cover. The attachment is preferably implemented so that the circuit board also functions as a supporting structural element in the device.

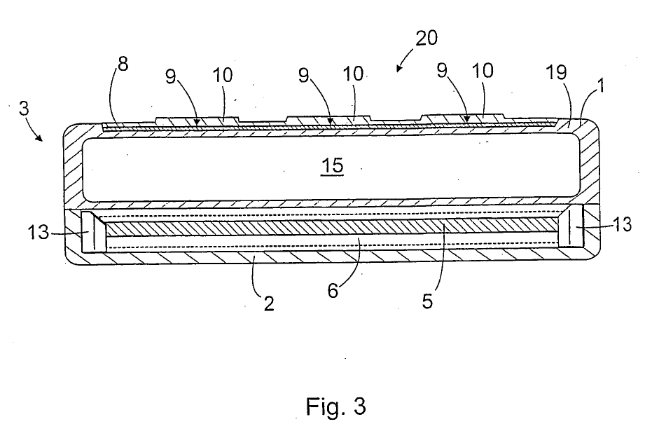

FIG. 3 schematically illustrates another electronic device according to the invention as a cross section at the keyboard. The keydome 8 is attached to the power source element 3, which is integrated into the front cover 1. Thus the front cover 1 also functions as a protective cover 19 for the power source element. The actual power source is mounted in a space 15 for the power source. It should be noted that the power source is not shown in the figure.

The keydome 8 is mounted in a recess provided in the front cover 1, and the keyboard 20, which in this case is a membrane keyboard, is arranged on top of the keydome. In other words, the keyboard 20 keys 10 are attached to the power source element 3. The keydome 8 comprises a membrane switch 9 under each key, which generates an electric signal when the key is pressed appropriately.

The circuit board 5 and its components 6 are attached to the back cover 2 by means of the attachment members 13.

An advantage of the device shown in FIG. 3 is that its structure and assembly are very simple. In addition, its structure can be rendered very thin since the front cover 1 also functions as the protective cover 19 for the power source element, which makes a separate protective cover unnecessary. In addition, the front cover 1 can be provided with a case-like structure having a very good torsional rigidity. Thanks to this, the mechanical rigidity of the device will be sufficient even though the wall thickness of the device cover is reduced more than usual.

The drawings and the related description are only intended to illustrate the inventive concept. The details of the invention may vary within the scope of the claims. Thus other components related to the keyboard may be integrated into the power source element 3, for example an optical cable or a light source for illuminating the keyboard. For example, it is rather simple to integrate an electro-luminescent keyboard light source: one thin electroluminescent film is arranged between the keyboard and the power source element 3.

1. An electronic device which comprises a power source element and a keyboard, which keyboard includes a keydome, that keydome is attached to the power source element.

2. An electronic device according to claim 1, wherein the keydome is detachably attached to the power source element.

3. An electronic device according to claim 1, wherein the keydome establishes a part of a protective casing of the power source.

4. An electronic device according to claim 1, wherein the power source element is integrated into the casing of the device.

5. An electronic device according to claim 1, wherein keys related to the keydome are arranged in the power source element.

6. An electronic device according to claim 1, wherein the power source element is arranged as part of the supporting structure of the device.

7. An electronic device according to claim 1, wherein it is a mobile phone or a communicator.

8. A power source element for an electronic device which comprises power source and a casing covering it, wherein the power source element further comprises a keydome.

9. A power source element according to claim 8, wherein the power source is a chargeable battery.

10. A power source element according to claim 8, wherein the power source is a disposable battery.

11. A power source element according to claim 8, wherein keys related to the keydome are arranged in the power source element.

12. A method of optimising the structure of an electronic device, which comprises a power source element and a keyboard, which keyboard includes a keydome that is attached to the power source element.

13. A method according to claim 12, wherein the power source element is integrated into the casing of the device.

14. A method according to claim 12, wherein keys related to the keydome are attached to the power source element.

15. A method according to claim 12, wherein the power source element is formed as part of the supporting structure of the device.
